(19) United States
(12) Patent Application Publication
(10) Pub. No.: US 2022/0344777 A1
(43) Pub. Date: Oct. 27, 2022

(54) CONDUCTIVE STRAP FOR BATTERY PACK

(71) Applicant: MILWAUKEE ELECTRIC TOOL CORPORATION, Brookfield, WI (US)

(72) Inventors: Wyatt R. Silha, Milwaukee, WI (US); Joel D. Snyder, Milwaukee, WI (US); Cameron R. Schulz, Milwaukee, WI (US); Gurusiddeshwar Gudimani, Plymouth, WI (US); Natalie A. Olsen, Milwaukee, WI (US); John G. Marx, Hartford, WI (US); Zachery D. Meyer, Hartland, WI (US); Eli M. Zidel, Milwaukee, WI (US)

(21) Appl. No.: 17/727,115

(22) Filed: Apr. 22, 2022

Related U.S. Application Data
(60) Provisional application No. 63/292,145, filed on Dec. 21, 2021.
(60) Provisional application No. 63/183,267, filed on May 3, 2021.
(60) Provisional application No. 63/178,829, filed on Apr. 23, 2021.

(51) Int. Cl. H01M 50/503; H01M 50/516

(52) U.S. Cl. CPC H01M 50/503; H01M 50/516

(57) ABSTRACT

A conductive strap for a battery pack including a pair of contact tabs and a cutout portion. The contact tabs are separated by a separation gap that is defined in the conductive strap. Each contact tab includes at least one contact dimple. The separation gap is continuous with the cutout portion. The cutout portion and the separation gap are enclosed by the conductive strap. The cutout portion includes an arcuate slot that partially surrounds the contact tab.

### CROSS-REFERENCE TO RELATED APPLICATIONS

This application claims priority to prior-filed, co-pending U.S. Provisional Patent Application No. 63/178,829, filed on Apr. 23, 2021, U.S. Provisional Patent Application No. 63/183,267 filed on May 3, 2021, and U.S. Provisional Patent Application No. 63/292,145, filed on Dec. 21, 2021, the entire contents of which are incorporated herein by reference.

### FIELD OF THE DISCLOSURE

The present invention relates to conductive straps, and more particularly to conductive straps for battery packs.

### BACKGROUND OF THE DISCLOSURE

In creating a conductive strap to electrically connect one or more battery cells to one another or other components of a battery pack, it is important to provide good electrical conduction. In many applications, it can also be beneficial to provide adequate thermal conduction via the conductive strap, such that the conductive strap may act as a heat sink for the heat produced by the electricity traveling to and/or from the battery cells. In order to provide the best possible heat sink capability, the conductive strap should be made of as much material as possible, particularly along the current carrying path, providing a large enough cross-sectional area to effectively pull heat away from the battery cells.

Also, in creating a conductive strap, it can be beneficial to provide the conductive strap with contact tabs that are at least somewhat flexible relative to the remainder of the conductive strap. These contact tabs should be flexible enough to allow a welding head to press a respective contact tab against and into engagement with the end of a corresponding battery cell. The contact tab and the end of the battery cell are then resistance welded together by the welding head. For this manufacturing technique, it is generally true that the more the contact tab can flex relative to the remainder of the conductive strap, the easier and better quality the welding operation becomes.

The present disclosure takes these two desired features into account and balances them. Since increased flexibility often means reduced cross-section, one or more arrangements and forms of a conductive strap is sought herein to provide an optimization of both thermal conductivity and flexibility for manufacturing.

### SUMMARY OF THE INVENTION

The invention provides, in one aspect, a conductive strap for a battery pack including a pair of contact tabs and a cutout portion. The contact tabs are separated by a separation gap that is defined in the conductive strap. Each contact tab includes at least one contact dimple. The separation gap is continuous with the cutout portion. The cutout portion and the separation gap are enclosed by the conductive strap. The cutout portion includes an arcuate slot that partially surrounds the contact tab.

The invention provides, in another aspect, a conductive strap for a battery pack having a plurality of battery contact portions. Each battery contact portion has at least one contact tab. Each contact tab has at least one contact dimple. A subset of the battery contact portions include more than one contact tabs and at least one battery contact portion includes a single contact tab.

The invention provides, in yet another aspect, a method of installing a conductive strap on a battery cell. The method includes aligning a pair of contact tabs of the conductive strap to an end of the battery cell. The pair of contact tabs are at least partially surrounded by an arcuate slot. Then, a welding header presses against the pair of contact tabs of the conductive strap towards the end of the battery cell. Next, a connection extension piece corresponding to each contact tab is flexed to independently move the contact tabs relative to the remainder of the conductive strap. This action engages the end of the battery cell with contact dimples of the contact tabs. Finally, the pair of contact tabs are resistance welded to the end of the battery cell at the contact dimples.

### BRIEF DESCRIPTION OF THE DRAWINGS

FIG. 1 is a perspective view of a plurality of conductive straps for a battery pack, according to embodiments disclosed herein.

FIG. 2 is a top plan view of the conductive straps of FIG. 1.

FIG. 3 is an exploded perspective view of the conductive straps of FIG. 1.

FIG. 4 is a perspective view of the conductive straps of FIG. 1 disposed within an overmolded body of a battery pack.

FIG. 5 is a side elevation cross-sectional view of a conductive strap of FIG. 1 being resistance welded to a respective battery cell of a battery pack.

FIGS. 6A-6B are an assembly process of the conductive strap assembly.

FIG. 7 is a welded conductive strap assembly of the plurality of conductive straps of FIG. 1.

FIG. 8 is a perspective view of a conductive strap for a battery pack, according to embodiments disclosed herein.

FIG. 9 is a top plan view of the conductive strap of FIG. 8.

FIG. 10 is a side elevation view of the conductive strap of FIG. 8.

FIG. 11 is another perspective view of the conductive strap of FIG. 8.

FIG. 12 is a top plan view of another conductive strap for a battery pack, according to embodiments disclosed herein.

FIG. 13 is a top plan view of yet another conductive strap for a battery pack, according to embodiments disclosed herein.

FIG. 14 is a top plan view of another conductive strap for a battery pack, according to embodiments disclosed herein.

FIG. 15 is a top plan view of yet another conductive strap for a battery pack, according to embodiments disclosed herein.

FIG. 16 is a top plan view of still another conductive strap for a battery pack, according to embodiments disclosed herein.

FIG. 17 is a detailed top plan view of another conductive strap for a battery pack, according to embodiments disclosed herein.

FIG. 18 is another detailed top plan view of the conductive strap of FIG. 17.

FIG. 19 is a first gradient map showing directional deformation and a second gradient map showing current density of the conductive strap of FIG. 1.

FIG. 20 is a first gradient map showing directional deformation and a second gradient map showing current density of the conductive strap of FIG. 13.

FIG. 21 is another top plan view of the conductive strap of FIG. 8 with various measurements annotated thereon, the measurements being in millimeters.

FIG. 22 is a detailed top plan view of the area 22 shown in FIG. 21.

FIG. 23 is a detailed top plan view of the area 23 shown in FIG. 21.

FIG. 24 is a side elevation view of the conductive strap of FIG. 8 with various measurements annotated thereon, the measurements being in millimeters.

FIG. 25 is a detailed side elevation view of the area 25 shown in FIG. 24.

FIG. 26 is a top plan view of a conductive strap for a battery pack, according to embodiments disclosed herein.

FIG. 27 is a top plan view of a conductive strap for a battery pack, according to embodiments disclosed herein.

FIG. 28 is a top plan view of another conductive strap for a battery pack, according to embodiments disclosed herein.

FIG. 29 is a top plan view of another conductive strap for a battery pack, according to embodiments disclosed herein.

FIG. 30 is a perspective view of a conductive strap for a battery pack, according to embodiments disclosed herein.

FIG. 31 is a top plan view of a conductive strap of FIG. 30.

FIG. 32 is a gradient map showing current density of a conductive strap for a battery pack, according to embodiments disclosed herein.

FIG. 33 is a gradient map showing current density of a conductive strap of FIG. 30.

FIG. 34 is a gradient map showing current density of various conductive straps, according to embodiments disclosed herein.

FIG. 35 is a table of flexibility measurements of various conductive straps, according to embodiments disclosed herein.

FIG. 36 is a perspective view of a battery pack in accordance with an embodiment of the present disclosure.

FIG. 37 is an enlarged view of the battery pack of FIG. 36.

Features and aspects of the disclosure will become apparent by consideration of the following detailed description and accompanying drawings.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

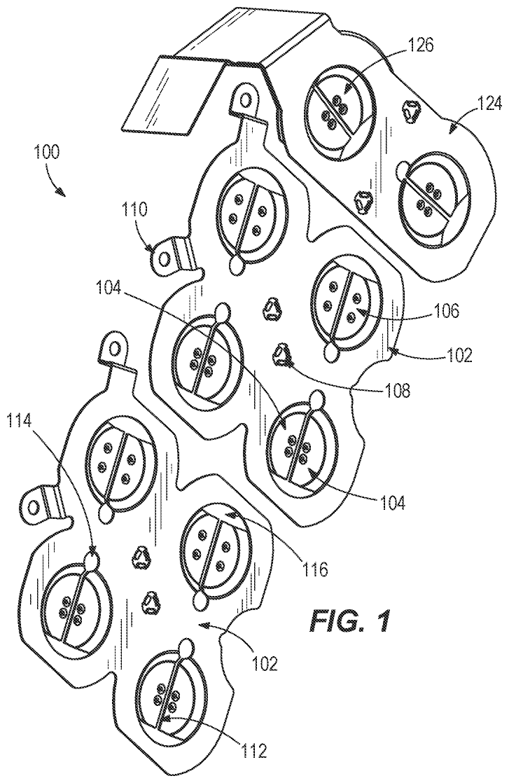

With reference to FIGS. 1-3, an embodiment of a conductive strap assembly 100 for use with a battery pack is shown. Depending on the number of battery cells, the conductive strap assembly 100 may include one or more conductive straps 102. Each conductive strap 102 includes at least one pair of contact tabs 104. Each contact tab 104 is provided with one or more contact dimples 106, which are arranged to protrude toward an adjacent end of a battery cell (discussed more below). Each conductive strap 102 may be manufactured by, for instance, stamping the shape out of a sheet of metal. The conductive straps 102 may include a plurality of mount holes 108 defined therein for fastening the conductive straps 102 to other components of the battery pack. In the illustrated embodiment, some of the mount holes 108 are defined in mount tabs 110 that protrude from the remainder of the conductive strap 102.

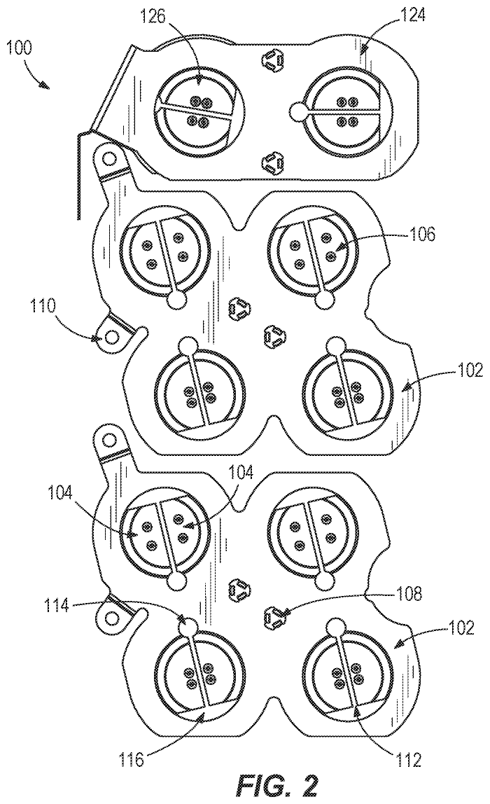

As best shown in FIG. 2, each conductive strap 102 may have a generally planar sheet-like shape. Each contact tab 104 in the illustrated embodiment is formed in a recessed shape as a majority of a semicircle concaved or recessed on the same side of the conductive strap. In the illustrated embodiment, the contact tabs 104 have a truncated semicircular shape. A separation gap 112 is defined in the conductive strap 102 and is disposed between each pair of contact tabs 104. In the illustrated embodiment, the separation gap 112 is continuous with a cutout portion. The cutout portion includes a first cutout portion 116 at one end of the separation gap 112 and a second cutout portion at the other end of the separation gap 112. The second cutout portion is a circular hole 114. The separation gap 112 and the cutout portion 116 are enclosed by the conductive strap 102. The enclosed area around the separation gap 112 and the cutout portion 116 may be circular. The separation gap 112, circular hole 114, and cutout portion 116 all cooperate to provide improved flexibility of the contact tabs 104. The contact tabs 104 may be asymmetrical. The radial asymmetry provided to each contact tab due to the cutout portion 116, which is located away from the current carrying path, allows for an increase in the cross-sectional area of the contact tab about the current carrying path while maintaining a sufficient amount of flexibility. As such, improved thermal conductivity is also achieved even with the improved flexibility.

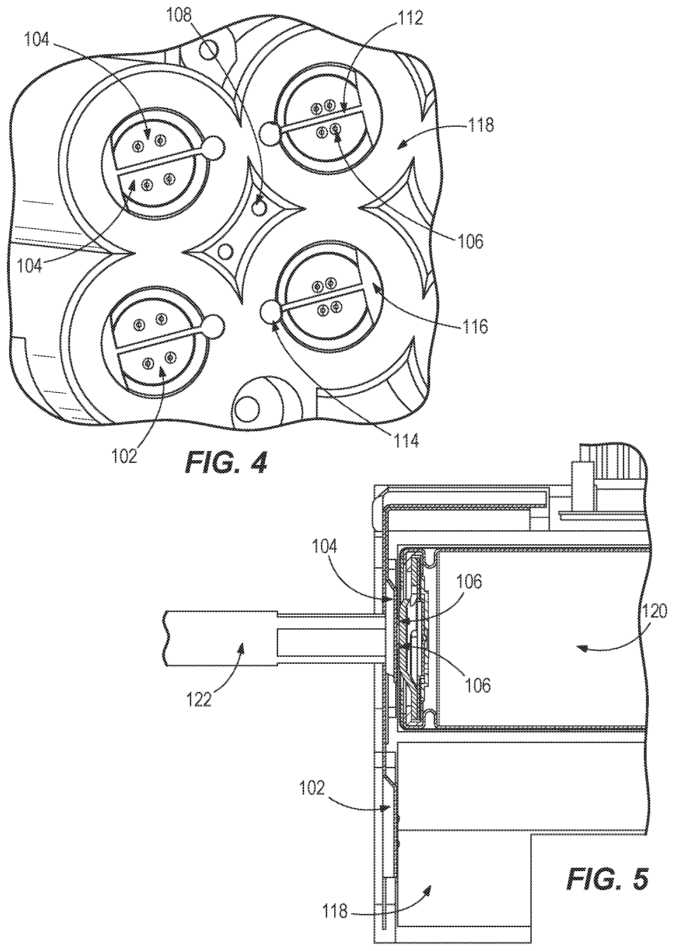

As shown in FIG. 4, the conductive straps 102 may be insert molded or overmolded into a structural member 118 of the battery pack. This manufacturing technique may allow for enhanced stability to avoid the welds breaking due to vibration. Further, insert molding the conductive straps 102 aids in locating the contact tabs 104 for the welding process described below.

With reference to FIG. 5, a welding process is shown. The conductive strap 102 is already insert molded in the structural member 118 of the battery pack. A battery cell 120 has been inserted in a cavity of the structural member 118. The pair of contact tabs 104 are aligned to an end of the battery cell 120. A welding header 122 presses against an outer surface of the conductive strap 102. Specifically, the welding header 122 presses against the contact tabs 104. The pressing force provided by the welding header 122 moves the contact tabs 104 toward the end of the battery cell 120. A connection extension piece corresponding to each of the contact tabs 104 is flexed to independently move the contact tabs 104 relative to the remainder of the conductive strap 102, thereby engaging the end of the battery cell 120 with the contact dimples 106 of the contact tabs 104. Current is then run through the contact tabs 104 to resistance weld the contact dimples 106 to the end of the battery cell 120.

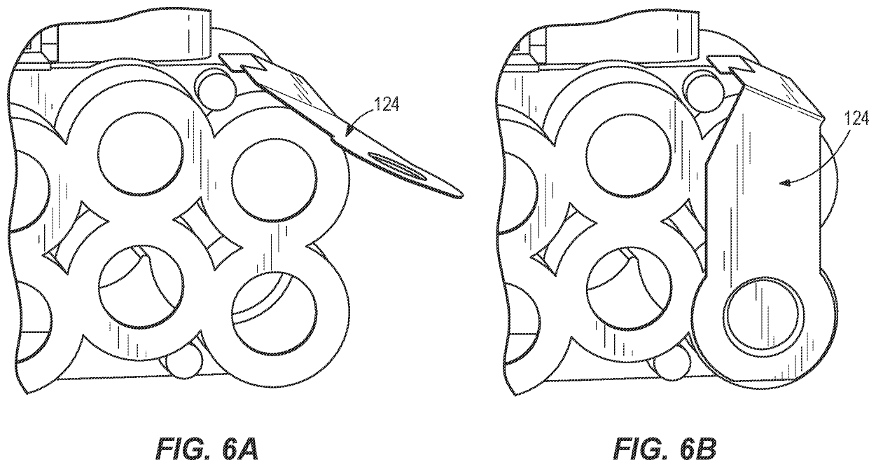

Turning to FIGS. 6A-6B, a corner strap 124 is shown being bent over and onto the conductive strap 102. This two-layer strap design allows for reduced chances of overheating the battery cell 120 adjacent the corner strap 124 when compared to a single layer design.

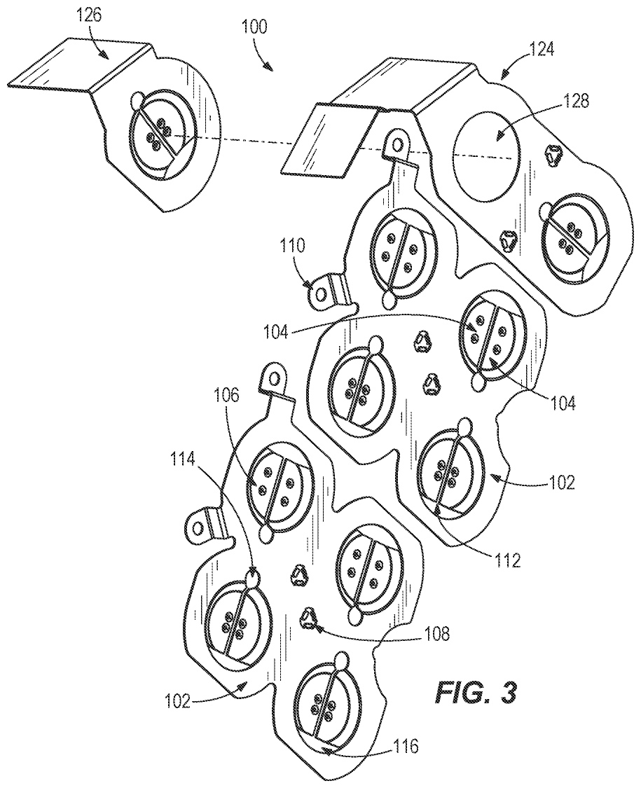

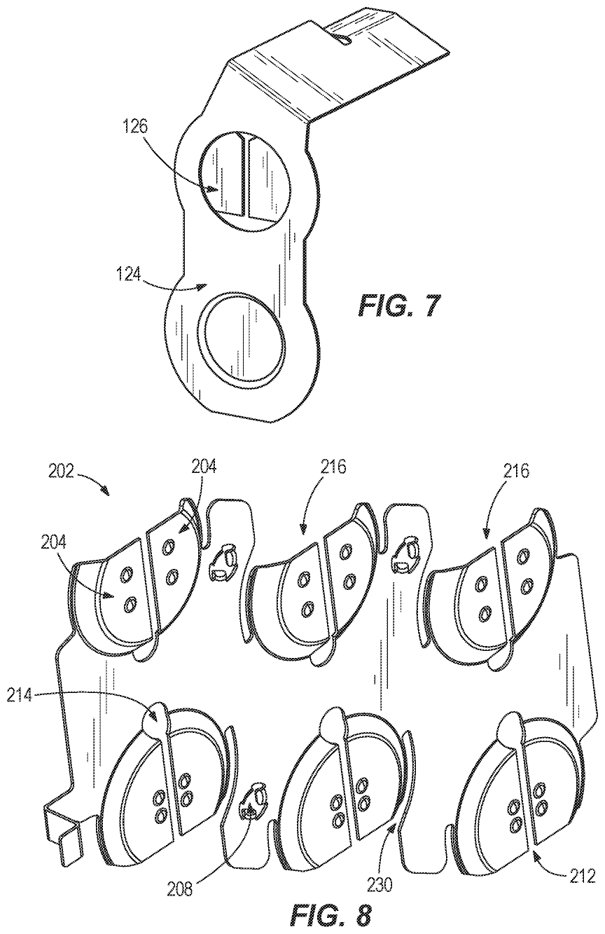

With reference to FIGS. 3 and 7, an embodiment including two corner straps 124, 126 is shown. Each of the corner straps 124, 126 of the illustrated embodiment also has a single pair of contact tabs 104. The longer corner strap 124, which is positioned over the outside of the shorter corner strap 126, includes a window opening 128 therein. In this manner, the welding header 122 can still reach the contact tabs 104 of the shorter corner strap 126 to resistance weld the contact dimples 106 to the end of the battery cell 120. In this illustrated arrangement, the contact tabs 104 of the shorter corner strap 126 are disposed between the battery cell 120 and the portion of the longer corner strap 124 defining the window opening 128. As shown in FIG. 7, the two corner straps 124, 126 are welded together using, for instance, laser welding to allow for more heat transfer between the two layers provided by the two corner straps 124, 126. Further, the two layers provided by the two corner straps 124, 126 provides additional strap material that reduces the likelihood of the adjacent battery cells 120 overheating. The additional material provided by the two-layer design provides better heat transfer capabilities than a single layer, while still allowing the contact tabs 104 to adequately flex for welding to the battery cells 120. This two-layer design also provides improved current carrying ability compared to a single layer. In some embodiments, each of the two corner straps 124, 126 is 0.25 millimeters thick. When laser welded together, the corner straps 124, 126 form a single cross-section with a 0.5 millimeter thickness.

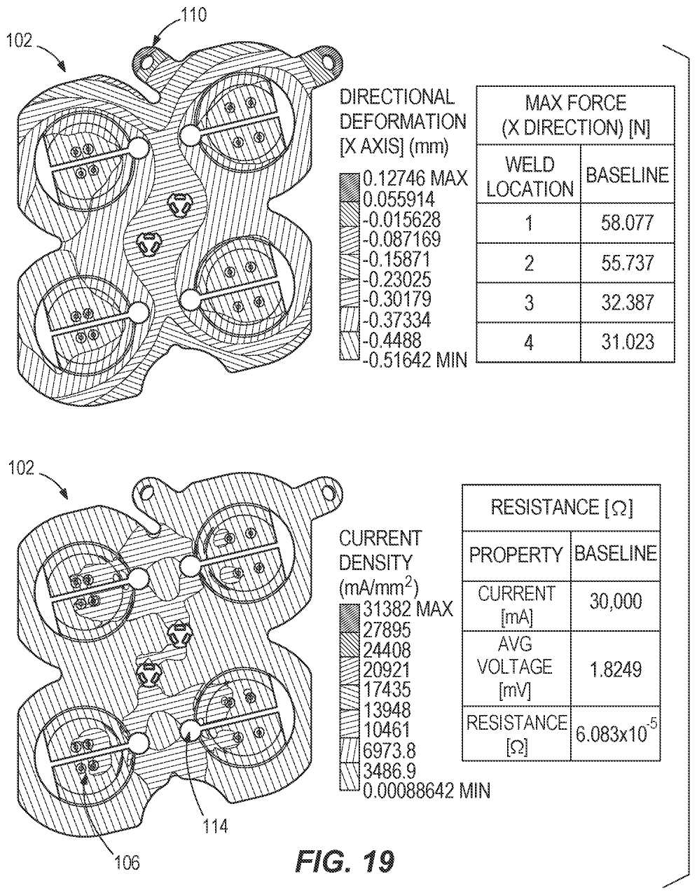

FIG. 19 shows the directional deformation of a set of conductive straps 102 after they have been welded onto the end of the of battery cells 120 and shows the current density of the set of conductive straps 102 while in operation. During welding, the welding header 122 makes contact with the set of conductive straps 102 at four different locations (e.g., on each pair of contact tabs 204) and can use a welding force that ranges from 31 N (Newtons) to 58.1 N (Newtons) to deform set of the conductive straps 102. The maximum negative deformation (i.e., deformation in the direction towards the battery cells 120) of the conductive strap 102 occurs at the contact tabs 104. The maximum positive deformation (i.e., deformation in the direction away from the battery cells 120) of the conductive strap 102 occurs on the mounting tabs 110. In some embodiment, the deformation may range from −0.51 millimeters to 0.12 millimeters. The current density of conductive strap 102, was measured using a baseline current of 30,000 mA (milliamps), an average voltage of 1.82 mV (millivolts), and a resistance of 6.1×10\hat{ }(−5)Ω (ohms). In some embodiments, the current density ranges from 0 mA/mm\hat{ }2 to 31382/mm\hat{ }2, and in some embodiments, the current density ranges from 0 mA/mm\hat{ }2 to 17435/mm\hat{ }2. The maximum current density of the conductive strap 102 may occur around the dimples 106 and the circular hole 114.

Turning now to FIG. 8, another embodiment of a conductive strap 202 is shown. Many features of the conductive strap 202 are similar to those discussed above with regard to the first embodiment of the conductive strap 102. As such, many of these features will not be discussed again below. Features similar to those discussed above will be labeled with a reference number that is a value of one hundred higher than the corresponding feature discussed above.

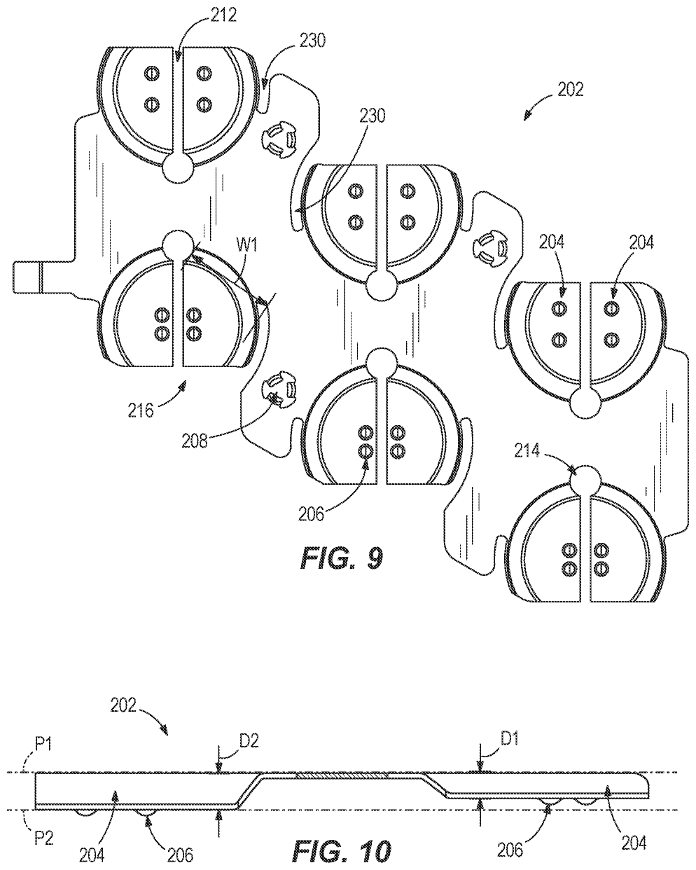

As best shown in FIG. 9, the conductive strap 202 provides even more flexibility of the contact tabs 204. This flexibility is due to the arcuate slot 230 defined in the conductive strap 202. The arcuate slot 230 at least partially surrounds the respective contact tabs 204. The arcuate slot 230, the first cutout portion 216 and the separation gap 212 are continuous. Further, the cutout portion 216 is no longer surrounded by additional strap material. Instead, each cutout portion 216 forms a portion of the overall outer perimeter of the conductive strap 202, thereby reducing material in a portion of the conductive strap 202 that is not arranged in the current carrying path. In the illustrated embodiment, the width W1 of the conductive strap 202 at a current carrying location is between 5 millimeters and 10 millimeters. Some embodiments include the width W1 being between 7 millimeters and 8 millimeters. Some embodiments include the width W1 being 7.83 millimeters.

As shown in FIG. 10 the conductive strap 202 further includes the contact tabs 204 recessed relative to the remainder of the conductive strap 202. An angled extension connects the contact tab 204 to the remainder of the conductive strap 202. The conductive strap defines a conductive strap plane P1, while the contact tabs 204 define a contact tab plane P2 that is parallel and offset from the conductive strap plane P1. The angled extension spans between the conductive strap plane P1 and the contact tab plane P2. The contact tab plane P2 may be offset from the conductive strap plane P1 by distance ranging from 0.5 millimeters to 2.0 millimeters.

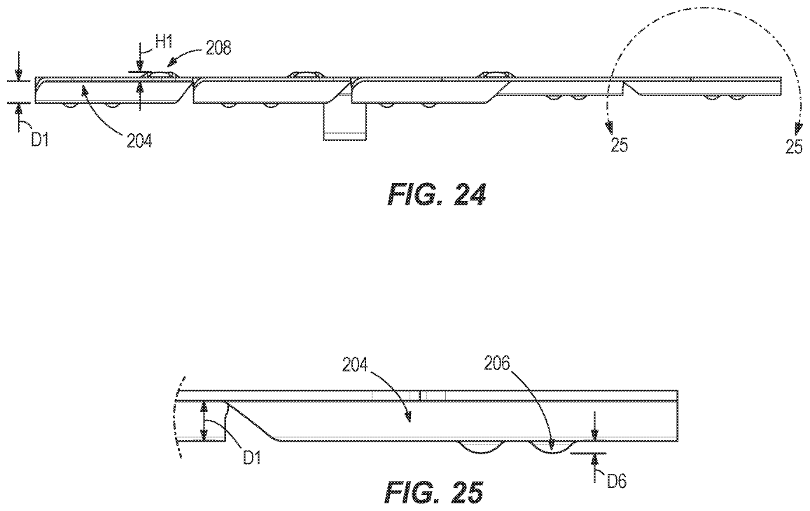

Because the positive end of some battery cells 120 projects farther longitudinally than the negative end of the cell, the illustrated embodiment has contact tabs 204 that are recessed by different depths to correspond to the end of the respective battery cell 120. As such, the illustrated embodiment includes a shorter recess depth D1 for the contact tabs 204 that correspond to a positive end of a battery cell 120 than the recess depth D2 for the contact tabs 204 that correspond to a negative end of a battery cell 120. In some embodiments, the shorter recess depth D1 is between 0.5 millimeters and 1.5 millimeters, and the longer recess depth D2 is between 1.5 millimeters and 2.5 millimeters. In some embodiments, the shorter recess depth D1 is between 0.75 millimeters and 1.25 millimeters, and the longer recess depth D2 is between 1.5 millimeters and 2.0 millimeters. In some embodiments, the shorter recess depth D1 is 1 millimeter, and the longer recess depth D2 is 1.55 millimeter. These unequal recess depths D1, D2 allow for improved welds between the contact tabs 204 and the respective ends of the battery cells 120. Of course, other embodiments may include the recess depths D1, D2 being equal to accommodate battery cells 120 that do not project farther on the positive end than the negative end. As seen in FIG. 24, in some embodiments, the mount hole 208 may extend past the conductive strap 202 at a height H1 that ranges from 1.00 millimeters to 0.10 millimeters. In some embodiments the height H1 may range from 0.50 to 0.30 millimeters. In a preferred embodiment, the height H1 is 0.37 millimeters. Additionally, as seen in FIG. 25, the dimples 206 may extend past the recess depth D1, D2 of the contact tabs 204. In some embodiments, this additional depth D6 may range from 1.0 millimeters to 0.1 millimeters. In some embodiments the additional depth D6 may range from 0.6 to 0.2 millimeters. In a preferred embodiment, the depth D6 is 0.3 millimeters.

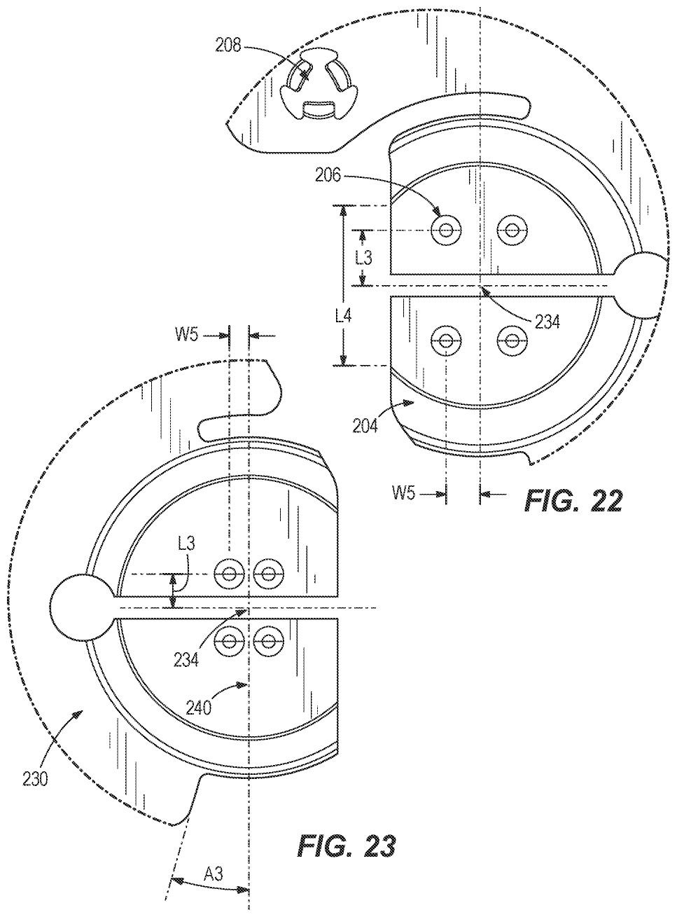

As seen in FIGS. 21-23, in some embodiments, the diameter of the mount holes 208 range from 2.5 millimeters to 4.5 millimeters. In some embodiments, the diameter of the mount holes 208 range from 3.0 to 4.0 millimeters, and in some embodiments the diameter may range from 3.4 millimeters to 3.6 millimeters. The length L1 between the mount hole 208 and the separation gap 212 may range from 11.0 millimeters to 9.00 millimeters in some embodiments. In some embodiments, the length L1 may range from 10.00 millimeters to 9.5 millimeters. In some embodiments, the length L1 may be 9.85 millimeters. Additionally, the length L2 between a first mount hole 208a and a second mount hole 208a may range from 22 millimeters to 18 millimeters in some embodiments. In some embodiments, the length L2 may range from 21 to 20 millimeters. In some embodiments, the length L2 may be 20.20 millimeters. The width W4 between the first mount hole 208a and a third mount hole 208c may range from 25 millimeters to 22 millimeters in some embodiments. In some embodiments, the width W4 may range from 24 millimeters to 23 millimeters. In some embodiments the width W4 may be 23.9 millimeters. Between the dimples 206, there is a center point 234. The center point 234 may align with the center point of the end of the battery cell 120. The length L3 between a dimple 206 and the separation gap 212 may range from 1.00 millimeters to 3.00 millimeters in some embodiments. In some embodiments, the length L3 may be around 1.55 millimeters. In some embodiments, the length L3 may be around 2.29 millimeters. The width W5 between the center point 234 and the dimple 206 may range from 2.00 millimeters to 0.5 millimeters in some embodiments. In some embodiments, the width W5 may be around 1.44 millimeters. In some embodiments, the width W5 may be around 0.85 millimeters. The contact tabs 204 that have a dimples 206 that are closer together (FIG. 23) may correspond with the positive end of the battery cell 120, while the contact tabs 204 that have dimples 206 that are more spaced (FIG. 22) may correspond with the negative end of the battery cell 120. A length L4 is between a dimple 206 and the furthest edge of the contact tab 204. In some embodiments, the length L4 may range from 1.0 to 3.0 millimeters. In some embodiments, the length L4 may range from 2.0 to 3.0 millimeters. In some embodiments, the length L4 is 2.28 millimeters. In some embodiments, the separation gap 212 may have a thickness that ranges from 2.00 millimeters to 0.5 millimeters. In some embodiments, the thickness of the separation gap 212 may range from 1.5 millimeters to 0.75 millimeters. In some embodiments, the thickness of the separation gap 212 may be 1 millimeter. The circular hole 214 may have a diameter that ranges from 2.00 millimeters to 4.00 millimeters in some embodiments. In some embodiments, the diameter of the circular hole 214 may range 3.00 to 4.00 millimeters. In some embodiments, the diameter of the circular hole 214 is 3.00 millimeters. An angle A3 is formed between the center line 238 of the center point 234 and the end of the arcuate slot 230. In some embodiments, the angle A3 may range from 20 degrees to 10 degrees. In some embodiments, the angle A3 may range from 17 degrees to 15 degrees. In some embodiments, the angle A3 may be 16 degrees. In some embodiments, the distance between the mount hole 208 and the circular hole 214 may range from 15.00 millimeters to 12.00 millimeters, while in some embodiments this distance ranges from 13.00 to 12.00 millimeters. In some embodiments, the distance between the mount hole 208 and the circular hole 214 is 13.5 millimeters. The distance between the center point 234 and the circular hole may range from 4.00 to 6.00 millimeters in some embodiments. In some embodiments, the distance between the center point 234 and the circular hole may range from 5.00 to 5.50 millimeters, while in some embodiments the distance is 5.17

Turning now to FIG. 12, yet another embodiment of a conductive strap 302 is shown. Many features of the conductive strap 302 are similar to those discussed above with regard to the first embodiment of the conductive strap 102. As such, many of these features will not be discussed again below. Features similar to those discussed above will be labeled with a reference number that is a value of two hundred higher than the corresponding feature discussed above.

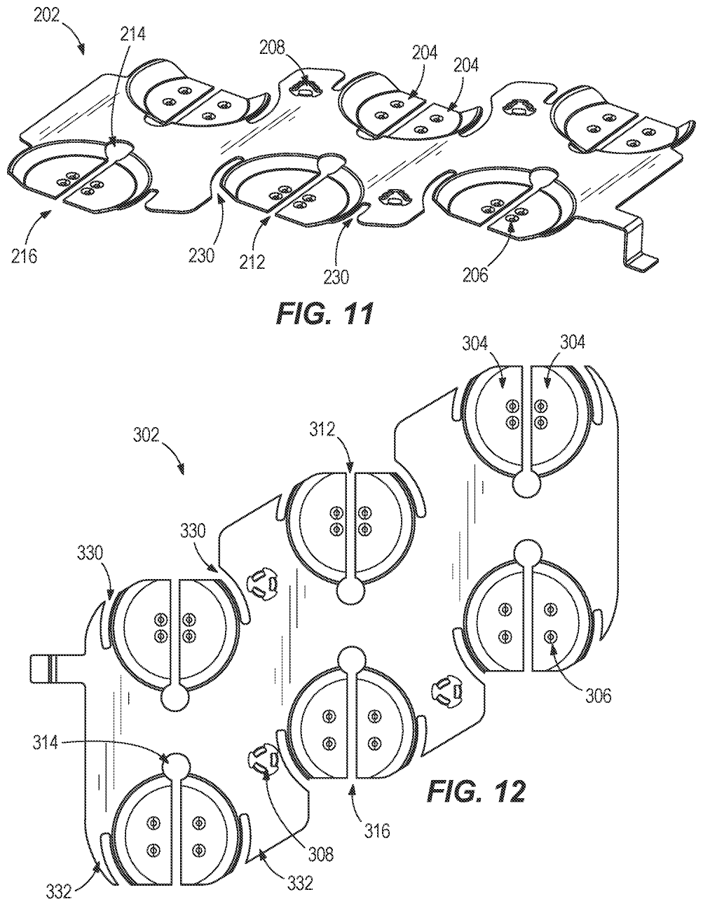

The conductive strap 302 is very similar to the conductive strap 202 shown in FIGS. 8-11, except the arcuate slots 330 are at least partially surrounded with extension sections 332. These extension sections 332 increase the amount of material of the conductive strap 302. Because the extension sections 332 are separated from the contact tabs 304 by the arcuate slots 330, the improved flexibility of the contact tabs 304 is maintained while the additional material provided by the extension sections 332 provides additional material to dissipate heat.

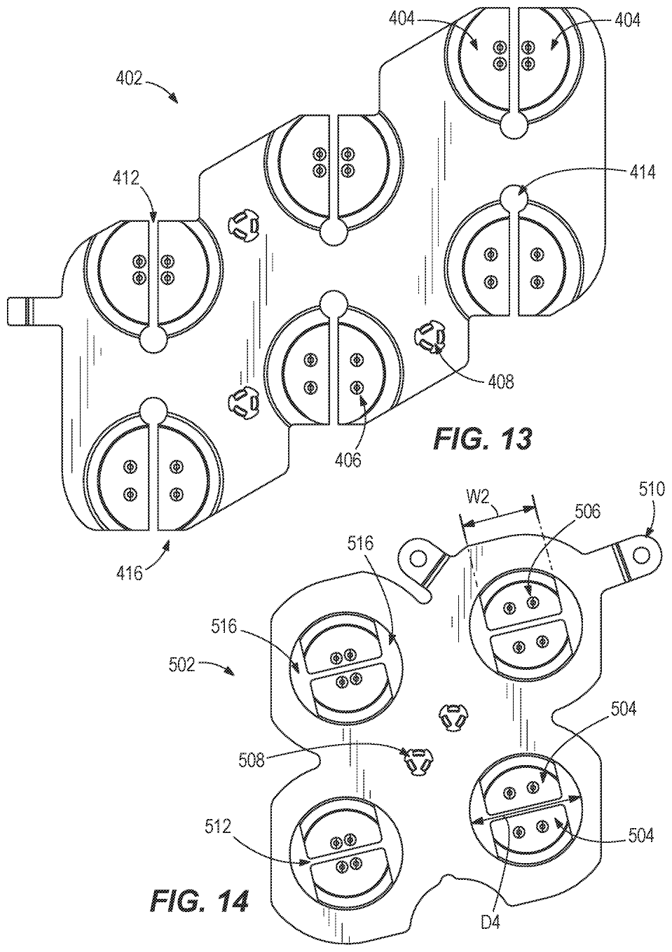

Turning now to FIG. 13, yet another embodiment of a conductive strap 402 is shown. Many features of the conductive strap 402 are similar to those discussed above with regard to the first embodiment of the conductive strap 102. As such, many of these features will not be discussed again below. Features similar to those discussed above will be labeled with a reference number that is a value of three hundred higher than the corresponding feature discussed above.

The conductive strap 402 is very similar to the conductive strap 202 shown in FIGS. 8-11, except the conductive strap 402 has no arcuate slots. This embodiment may be easier and/or cheaper to manufacture than the conductive strap 202, while still maintaining a satisfactory performance for both thermal conductivity about the current pathway and flexibility of the contact tabs 404.

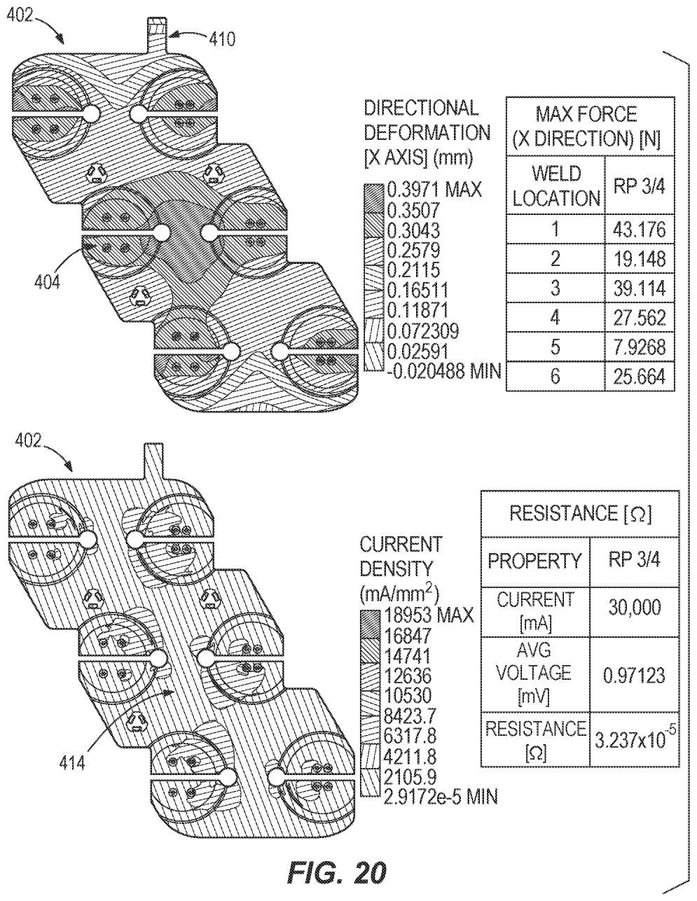

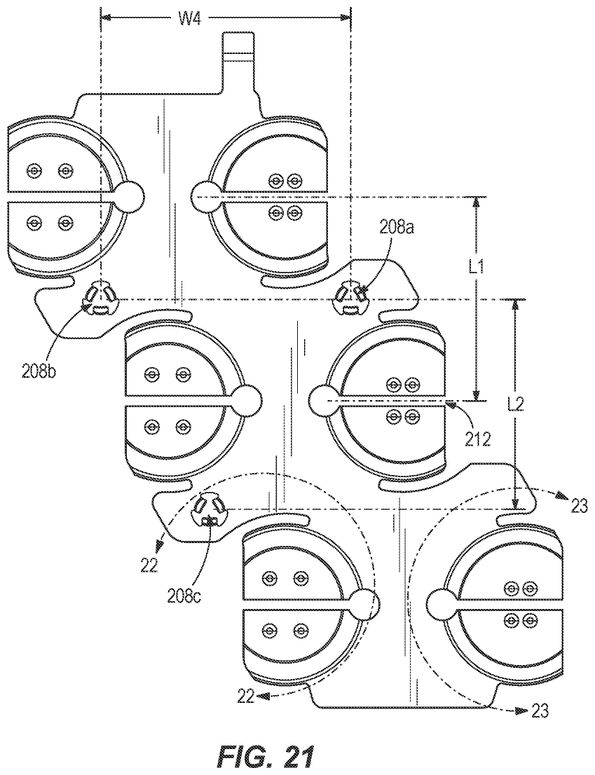

FIG. 20 shows the directional deformation of a set of conductive straps 402 after they have been welded onto a set of battery cells 420 and shows the current density of the set of conductive straps 402 in operation. During welding, the welding header 122 makes contact with the set of conductive straps 402 at six different locations (e.g., at each pair of contact tabs 404) and uses a welding force that ranges from 7.9 Newtons to 43.2 Newtons. The maximum negative deformation (i.e., deformation in the direction towards the battery cells 120) of the conductive strap 402 occurs at the mounting tabs 410. The maximum positive deformation (i.e., deformation in the direction away from the battery cells 120) of the conductive strap 402 occurs on the contact tabs 402. In some embodiments, the deformation may range from −0.02 millimeters to 0.39 millimeters. The current density of conductive strap 402, was measured using a baseline current of 30,000 mA (milliamps), an average voltage of 0.97 mV (millivolts), and a resistance of 3.23×10⁻⁵Ω (ohms). In some embodiments, the current density ranges from 0 mA/mm\hat{ }2 to 18953/mm\hat{ }2, and in some embodiments, the current density ranges from 0 mA/mm\hat{ }2 to 8423.7/mm\hat{ }2. The maximum current density of the conductive strap 402 may occur around the circular hole 414.

Turning now to FIG. 14, still another embodiment of a conductive strap 502 is shown. Many features of the conductive strap 502 are similar to those discussed above with regard to the first embodiment of the conductive strap 102. As such, many of these features will not be discussed again below. Features similar to those discussed above will be labeled with a reference number that is a value of four hundred higher than the corresponding feature discussed above.

The conductive strap 502 is similar to the conductive strap 102 shown in FIGS. 1-3, except the conductive strap 502 has no circular hole. Instead, the conductive strap 502 includes two cutout portions 516 defined therein on opposite sides of the contact tabs 504. The cutout portions 516 are also in communication with the separation gap 512, such that the contact tabs 504 are rectangular in shape. In some embodiments, each of the rectangular contact tabs 504 has a width W2 of between 7 millimeters and 12 millimeters. In some embodiments, the width W2 is between 8 millimeters and 11 millimeters. In some embodiments, the width W2 is between 9 millimeters and 10 millimeters. In some embodiments, the width W2 is 9.52 millimeters. In some embodiments, a diameter D3 of the arc formed by the outermost edge of the cutout portion 516 (e.g., the generally circular enclosed area that includes the separation gap 512 and the cutout portion 516) is between 12 millimeters and 17 millimeters. In some embodiments, the diameter D3 is between 13 millimeters and 15 millimeters. In some embodiments, the diameter D3 is 14 millimeters. In some embodiments, the diameter D3 is 14.026 millimeters.

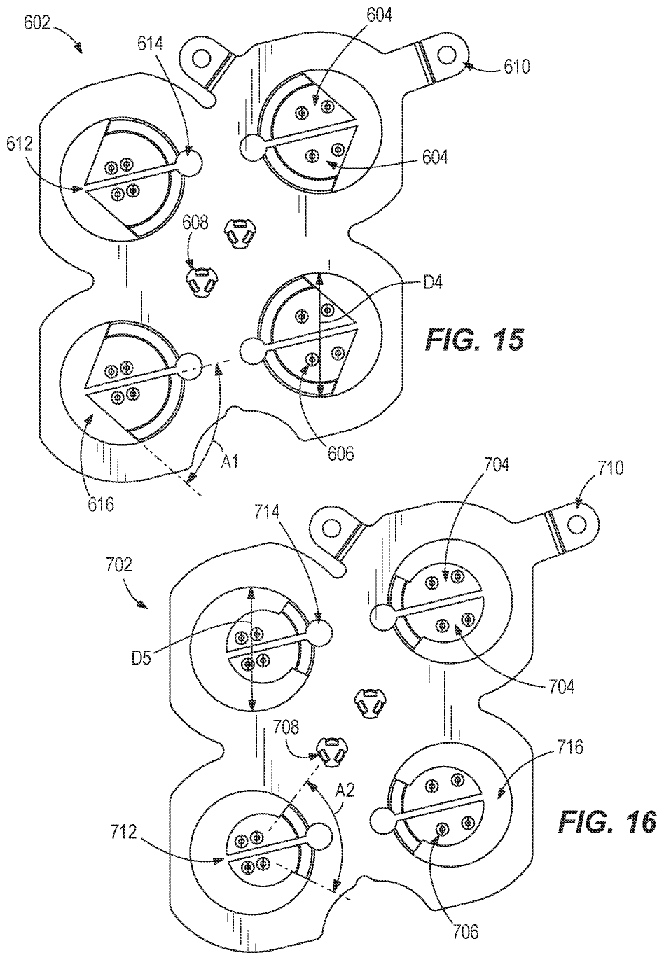

Turning now to FIG. 15, another embodiment of a conductive strap 602 is shown. Many features of the conductive strap 602 are similar to those discussed above with regard to the first embodiment of the conductive strap 102. As such, many of these features will not be discussed again below. Features similar to those discussed above will be labeled with a reference number that is a value of five hundred higher than the corresponding feature discussed above.

The conductive strap 602 is similar to the conductive strap 102 shown in FIGS. 1-3, except the conductive strap 602 includes a cutout portion 616 that is of a different shape. The cutout portion 616 is shaped such that the end of each of the contact tabs 604 comes to a point. The contact tabs 604 are generally triangular in shape, with the current carrying pathway being through the wide base of the triangle. In some embodiments, the angular contact tabs 604 come to a point that has an angle A1 of between 45 degrees and 65 degrees. Some embodiments include the angle A1 of between 50 degrees and 60 degrees. Some embodiments include the angle A1 of 55 degrees. In some embodiments, a diameter D4 of the arc formed by the outermost edge of the cutout portion 616 is between 12 millimeters and 17 millimeters. In some embodiments, the diameter D4 is between 13 millimeters and 15 millimeters. In some embodiments, the diameter D4 is 14 millimeters. In some embodiments, the diameter D4 is 14.036 millimeters.

Turning now to FIG. 16, another embodiment of a conductive strap 702 is shown. Many features of the conductive strap 702 are similar to those discussed above with regard to the first embodiment of the conductive strap 102. As such, many of these features will not be discussed again below. Features similar to those discussed above will be labeled with a reference number that is a value of six hundred higher than the corresponding feature discussed above.

The conductive strap 702 is similar to the conductive strap 102 shown in FIGS. 1-3, except the conductive strap 702 includes a cutout portion 716 that is of a different shape. The cutout portion 716 is arcuately shaped such that the end of each of the contact tabs 704 is rounded. The contact tabs 704 are generally semicircular in shape, with the current carrying pathway being through a connection extension meeting with the semicircular portion of the contact tab 704. In some embodiments, an angle A2 of the base of the pair of contact tabs 704 (e.g., an angle between the connection extension and each contact tab) is between 70 degrees and 90 degrees. Some embodiments include the angle A2 of between 75 degrees and 85 degrees. Some embodiments include the angle A2 of 78 degrees. The separation gap 712 and the circular hole 714 are included in the angle A2. In some embodiments, a diameter D5 of the arc formed by the outermost edge of the cutout portion 716 is between 12 millimeters and 17 millimeters. In some embodiments, the diameter D5 is between 13 millimeters and 15 millimeters. In some embodiments, the diameter D5 is 14 millimeters. In some embodiments, the diameter D5 is 14.045 millimeters.

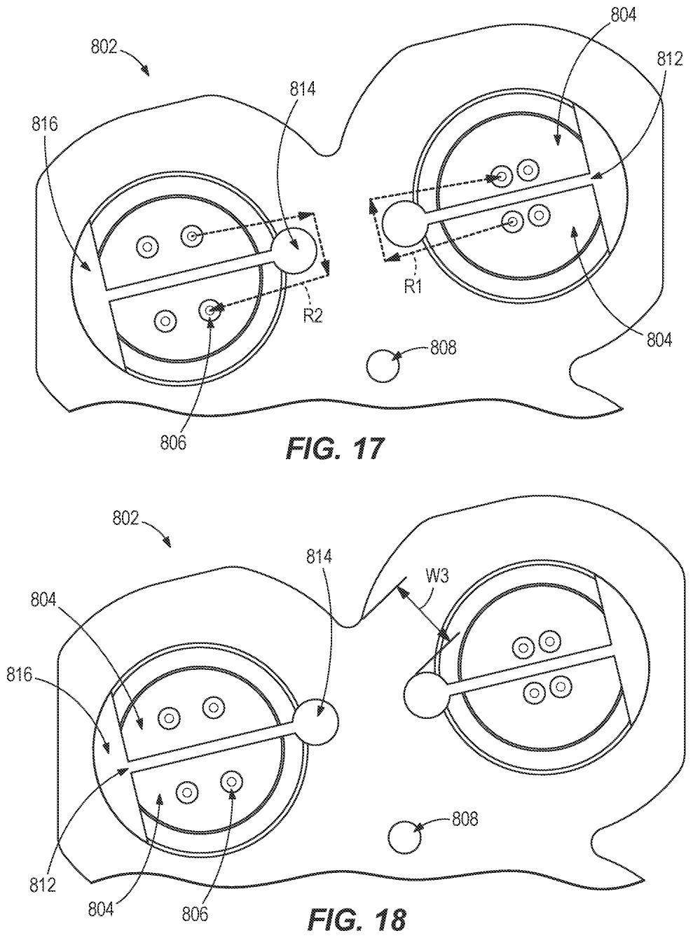

FIGS. 17 and 18 illustrate a detailed perspective view of another conductive strap 802. Many features of the conductive strap 802 are similar to those discussed above with regard to the first embodiment of the conductive strap 102. As such, many of these features will not be discussed again below. Features similar to those discussed above will be labeled with a reference number that is a value of seven hundred higher than the corresponding feature discussed above.

The conductive strap 802 includes a different layout of the contact dimples 806 for a positive end of a battery cell 120 compared to the contact dimples 806 for a negative end of a battery cell 120. Namely, one set of contact dimples 806 is farther away from the circular hole 814 than the other set of contact dimples 806 from the other respective circular hole 814. In some embodiments, the longer distance provides a route R1 from a first contact dimple 806 on first contact tab, about the circular hole 814, and to a second contact dimple 806 on a second adjacent contact tab 804 that separated from the first contact tab 804 by a separation gap 812. This route R1 is between 17.5 millimeters and 20 millimeters. In some embodiments, this route R1 is between 18 millimeters and 19 millimeters. In some embodiments, this route R1 is 18.11 millimeters. In some embodiments, the shorter distance provides a route R2 from one contact dimple 806, about the circular hole 814, and to the other contact dimple 806 on adjacent contact tabs 804 separated by a common separation gap 812. This route R2 is between 16.5 millimeters and 18 millimeters. In some embodiments, the route R2 is between 17 millimeters and 18 millimeters. In some embodiments, the route R2 is 17.14 millimeters.

As shown in FIG. 18, the conductive strap 802 also includes a width W3 of the conductive strap 802 through which the current carrying pathway travels. The width W3 may also be defined as the width between an edge of the conductive strap 802 and an outermost edge of the cutout portion 816. In some embodiments, the width W3 is between 4 millimeters and 6 millimeters. In some embodiments, the width W3 is between 4.5 millimeters and 5.5 millimeters. In some embodiments, the width W3 is 5 millimeters. In some embodiments, the width W3 is 5.0166 millimeters. In some embodiments, the width W3 may be greater than 6 millimeters. Some embodiments include a width W3 of between 6.5 millimeters and 10.5 millimeters. Some embodiments include a width W3 of between 7.5 millimeters and 9.5 millimeters. Some embodiments include a width W3 of 8.35 millimeters.

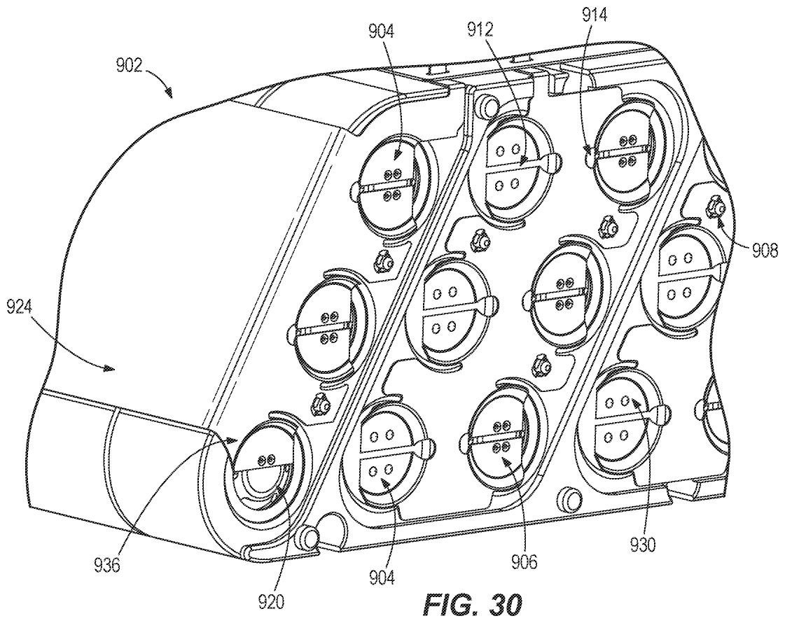

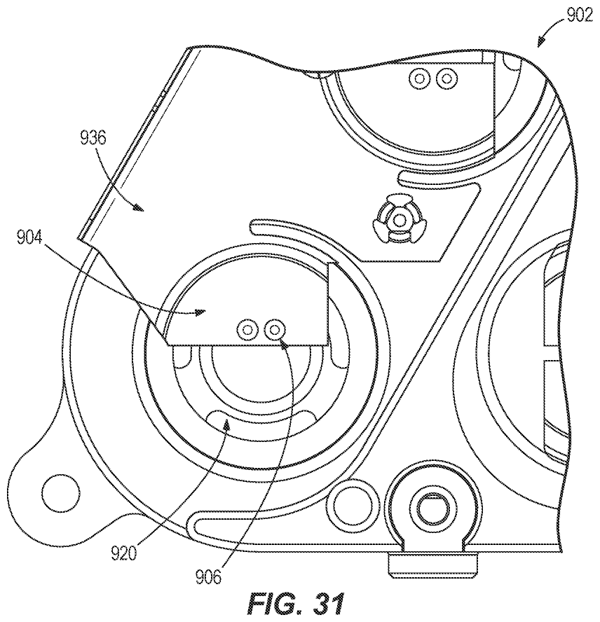

Turning now to FIGS. 30-31, still another embodiment of a conductive strap 902 is shown. Many features of the conductive strap 902 are similar to those discussed above with regard to the first embodiment of the conductive strap 102. As such, many of these features will not be discussed again below. Features similar to those discussed above will be labeled with a reference number that is a value of eight hundred higher than the corresponding feature of the conductive strap 102 discussed above.

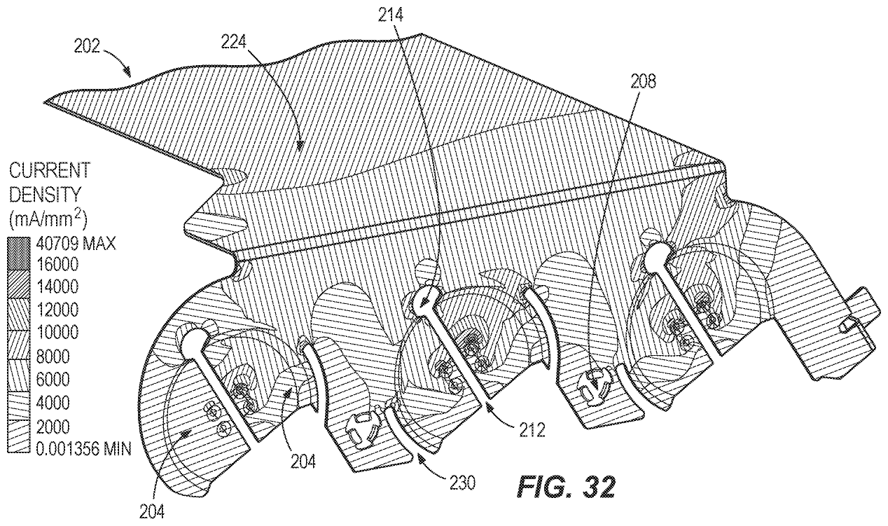

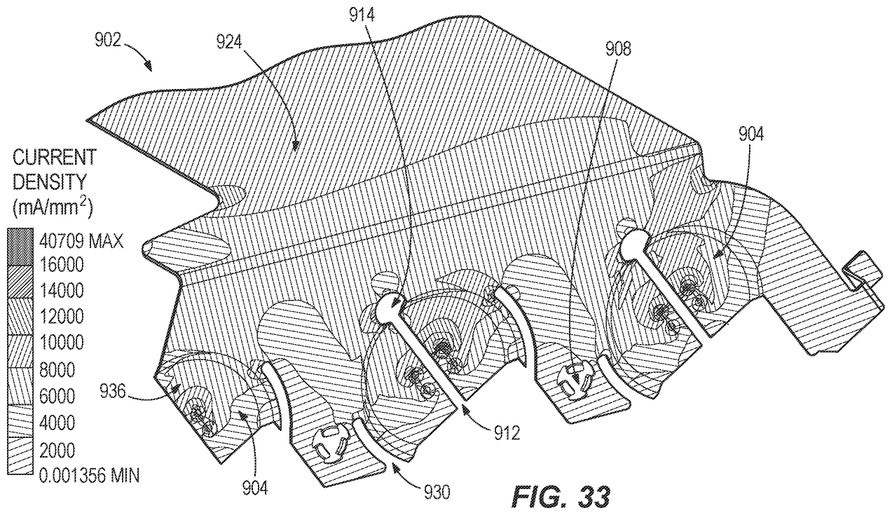

The conductive strap 902 differs from the conductive strap 202 shown in FIGS. 8-11, in that the conductive strap 902 has an endpiece 936 with an arrangement different from the remainder of the strap 902. The conductive strap 902 has a plurality of battery contact portions that include at least one contact tab 904. Each contact tab 904 has at least one dimple 906. The end piece 936 may be attached to a corner battery cell 920. The conductive strap 202 may have more than one end piece 936. On the end piece 936, illustrated in FIG. 30, there is only a single contact tab 904 which covers one half of the battery cell 920, while the remainder of the strap has a pair of contact tabs 904 covering the majority of the end of each of the remaining respective battery cells 920. Said another way, a subset of the battery contact portions includes more than one contact tab 904, while at least one battery contact portion (e.g., end piece 936) includes a single contact tab 904. The subset of battery contact portions may include all but one battery contact portions (e.g., end piece 936). Compared to the rest of the strap 902, the end piece 936 has a different arrangement. For example, the end piece 936 may have half the number of contact dimples 906 compared to the rest of the strap 902. Furthermore, the rest of the strap 902 has a separation gap 912 between the contact tabs 904 and a cutout portion 916 defined in the conductive strap 902. As shown in FIGS. 32-33, the current flow path and the overall resistance of the conductive strap 902 is similar to the current flow path and the overall resistance of the conductive strap 202. During manufacturing, the welding header 122 contacts both the cell head 920 and the conductive strap 902 when welding the end piece 936. This welding technique allows for the welding header 122 to use a lower force, compared to the welding of the rest of the conductive strap 902. This embodiment may be cheaper to manufacture than the conductive strap 202 since the amount of material is reduced. Although FIG. 30 shows the conductive strap 902 having a contact tab 904 with a geometry similar to the rectangular geometry of the contact tab 204, other geometries of contact tabs may be used (e.g., the triangular geometry of contact tab 604 or the semicircular geometry of contact tab 704).

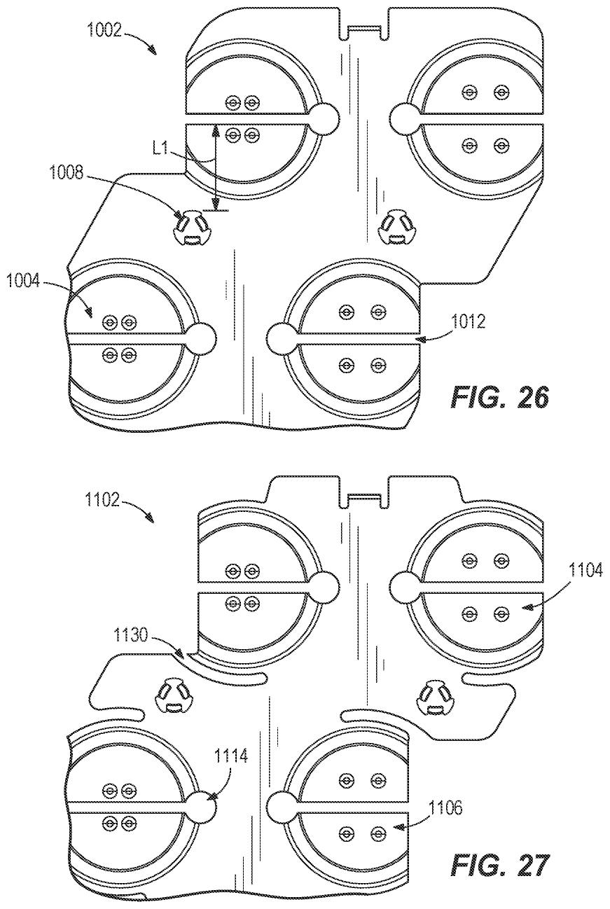

Turning now to FIG. 26, another embodiment of a conductive strap 1002 is shown. Many features of the conductive strap 1002 are similar to those discussed above with regard to the first embodiment of the conductive strap 102. As such, many of these features will not be discussed again below. Features similar to those discussed above will be labeled with a reference number that is a value of nine hundred higher than the corresponding feature of the conductive strap 102 discussed above.

The conductive strap 1002 differs from the conductive strap 102, shown in FIGS. 1-3, in that the conductive strap 1002 has a larger current pathway. The current pathway is increased by increasing the length L1 between the mount hole 1008 and the separation gap 1012. This increases the amount of material on the conductive strap 1002 between each pair of contact tabs 1004 and between the battery cells 120. A larger current pathway allows for the conductive strap 1002 to have less resistance loss and less thermal loss during operation.

In FIG. 27 another embodiment of a conductive strap 1102 is shown. Many features of the conductive strap 1102 are similar to those discussed above with regard to the first embodiment of the conductive strap 102. As such, many of these features will not be discussed again below. Features similar to those discussed above will be labeled with a reference number that is a value of one thousand higher than the corresponding feature of the conductive strap 102 discussed above.

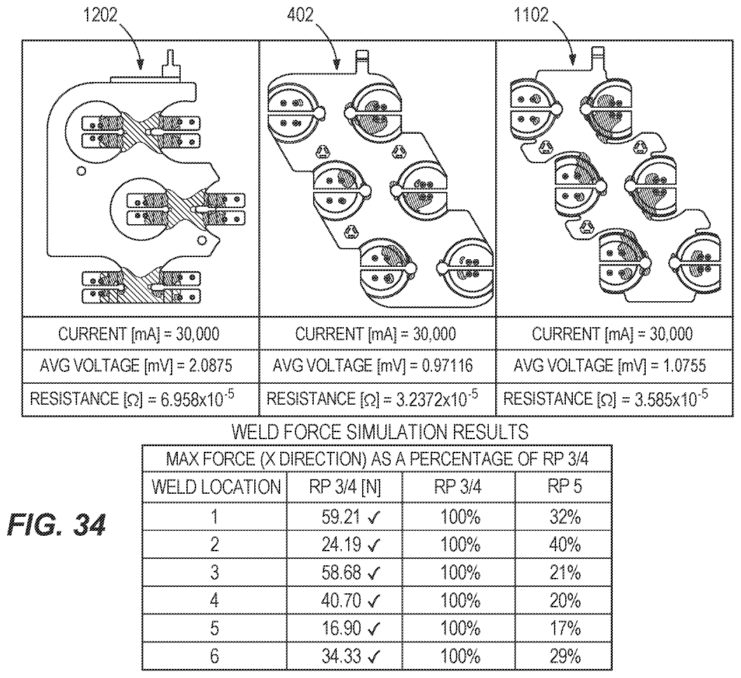

The conductive strap 1102 differs from the conductive strap 202, shown in FIGS. 8-11, in that the conductive strap 1102 has a larger contact tabs 1104. The larger contact tabs 1104 allows the conductive strap 1102 to have more contact with the end of the battery cell 120. This design also allows for a larger current pathway to be formed on the conductive strap 1102. The larger current pathway allows for the conductive strap 1102 to have less resistance loss and less thermal loss during operation. The larger contact tabs 1104 also allows the conductive strap 1102 to be used with larger battery cells 120. FIG. 34 shows a heat map of the current density of the conductive strap 1102 in operation. The current density of conductive strap 1102, was measured using a baseline current of 30,000 mA (milliamps), an average voltage of 1.08 mV (millivolts), and a resistance of 3.59×10⁻⁵Ω (ohms). The highest current density may occur near the circular hole 1114 and near the arcuate slot 1130.

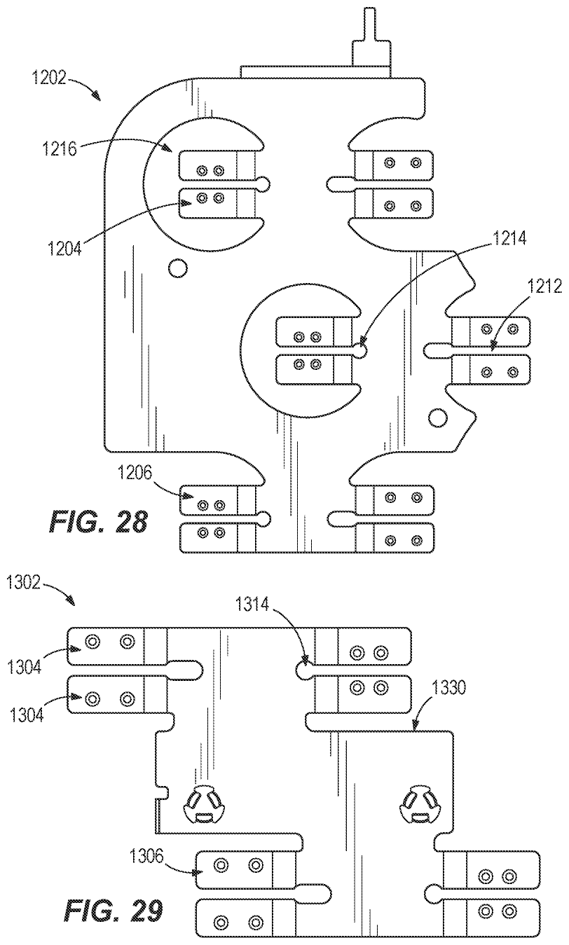

FIG. 28 shows another embodiment of a conductive strap 1202. Many features of the conductive strap 1202 are similar to those discussed above with regard to the first embodiment of the conductive strap 102. As such, many of these features will not be discussed again below. Features similar to those discussed above will be labeled with a reference number that is a value of eleven hundred higher than the corresponding feature of the conductive strap 102 discussed above.

The conductive strap 1202 differs from the conductive strap 102, shown in FIGS. 1-3, in that the conductive strap 1202 has slim, rectangular contact tabs 1104. The slim rectangular contact tabs 1104 allow for more flexibility in the conductive strap 1202. Additionally, the conductive strap 1202 has a larger cutout portion 1216. The larger cutout portion 1216 and the slim, rectangular tabs 104 allow for less material to be used in the conductive strap 1202. FIG. 34 shows a heat map of the current density of the conductive strap 1202. The current density of the conductive strap 1202, was measured using a baseline current of 30,000 mA (milliamps), an average voltage of 2.08 mV (millivolts), and a resistance of 6.96×10⁻⁵ Ω (ohms). The highest current density may occur near the circular hole 1214 and near the connection extension, where the conductive tabs 1204 connect with the rest of the conductive strap 102.

FIG. 29 shows another embodiment of a conductive strap 1302. Many features of the conductive strap 1302 are similar to those discussed above with regard to the first embodiment of the conductive strap 102. As such, many of these features will not be discussed again below. Features similar to those discussed above will be labeled with a reference number that is a value of twelve hundred higher than the corresponding feature of the conductive strap 102 discussed above.

The conductive strap 1302 differs from the conductive strap 1202, shown in FIG. 29, in that the conductive strap 1302 does not have a cutout portion that encloses the contact tabs 1302. Additionally, the conductive strap 1302 generally has more of a rectangular design. The slots 1330 are straight slots, instead of being arcuate slots. The rectangular design increases the current carrying pathway, which allows for less resistance loss and less thermal loss when the conductive strap 1302 is in use.

Turning to FIG. 34, the weld header 122 pressing force needed for installing conductive straps 1202 and 1102 are shown in view of conductive strap 402. During installation, the conductive straps 1202 and 1102 may require less force from the welding header 122 than conductive strap 402. Conductive strap 1202 can be installed using between 59% to 16.9% of the pressing force of conductive strap 402. The welding header 122 can use a pressing force to install the conductive strap 1202 that ranges from 25.4 Newtons to 1.34 Newtons. The conductive strap 1102 can be installed using between 40% to 17% of the pressing force of conductive strap 402. The welding header 122 can use a pressing force to install the conductive strap 1102 that ranges from 7.76 Newtons to 1.34 Newtons. This means that the conductive straps 1202 and 1102 are more flexible than the conductive strap 402.

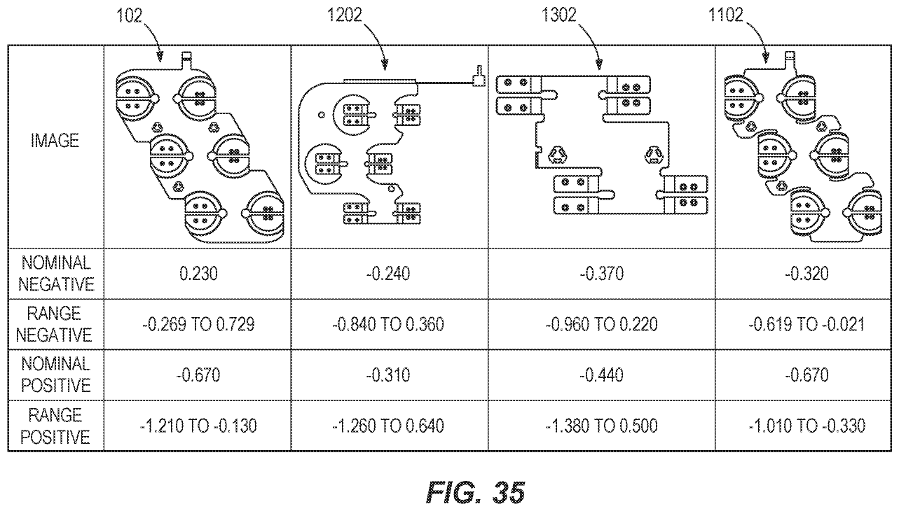

FIG. 35 shows the flexibility of conductive straps 102, 1202, 1302, and 1102. The flexibility is measured in terms of a negative range and a positive range. Conductive strap 102 has a negative range of about −0.27 to 0.73 millimeters and a positive range of −1.21 to 0.13 millimeters. Conductive strap 102 has a negative range of about −0.840 to 0.36 millimeters and a positive range of −1.26 to 0.64 millimeters. Conductive strap 1302 has a negative range of about −0.96 to 0.22 millimeters and a positive range of −1.38 to 0.5 millimeters. Finally, the conductive strap 1102 has a negative range of about −0.62 to −0.02 millimeters and a positive range of −1.01 to 0.33 millimeters.

At least some of the embodiments disclosed herein maximize the amount of conductive strap material around the end of each respective battery cell and maximize the width of the current carrying pathway. Insert molding the conductive strap in the structural member (such as the cell frame) of the battery pack may also increase the performance of carrying heat away from the battery cells. With at least some of the embodiments disclosed herein, the contact tabs provide a weld area on a majority of the positive end of the battery cell. In some embodiments, the contact tabs provide a weld area of greater than 75% of the positive end of the battery cell. In some embodiments, the contact tabs provide a weld area of greater than 85% of the positive end of the battery cell. In some embodiments, the contact tabs provide a weld area of between 85% and 90% of the positive end of the battery cell. In some embodiments, the contact tabs provide a weld area of 88.6% of the positive end of the battery cell. In some embodiments, the contact tabs provide a weld area of greater than 25% of the negative end of the battery cell. In some embodiments, the contact tabs provide a weld area of greater than 35% of the negative end of the battery cell. In some embodiments, the contact tabs provide a weld area of 35% to 45% of the negative end of the battery cell. In some embodiments, the contact tabs provide a weld area of 39.5% of the negative end of the battery cell. At least some of the embodiments disclosed herein have a strap thickness of between 0.2 millimeters and 0.5 millimeters. In some embodiments, the strap thickness is between 0.2 millimeters and 0.3 millimeters. In some embodiments, the strap thickness is 0.25 millimeters. In some embodiments, the cross-sectional area of the current carrying pathway is between 1 square millimeter and 2 square millimeters. In some embodiments, the cross-sectional area of the current carrying pathway is between 1 square millimeter and 1.5 square millimeters. In some embodiments, the cross-sectional area of the current carrying pathway is 1.254 square millimeters.

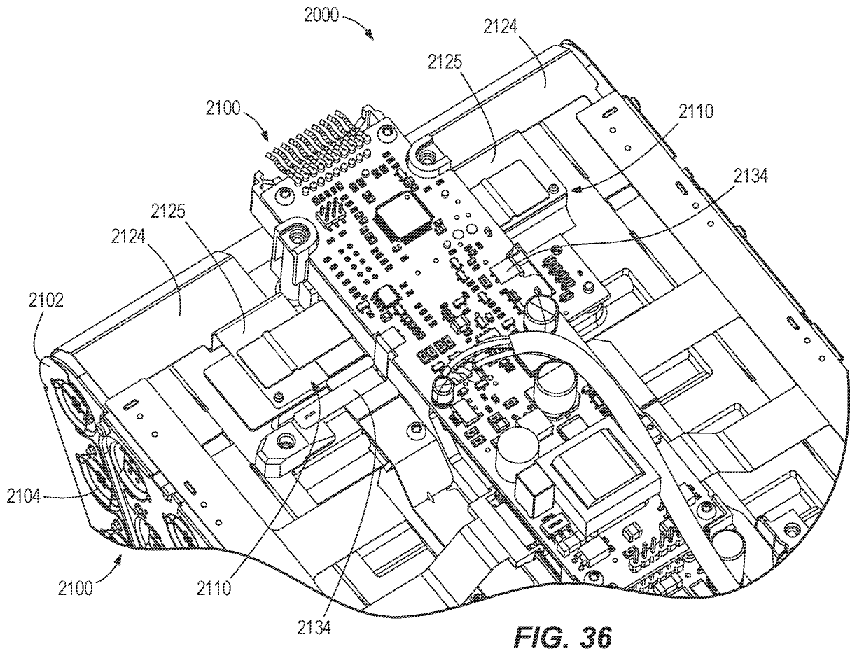

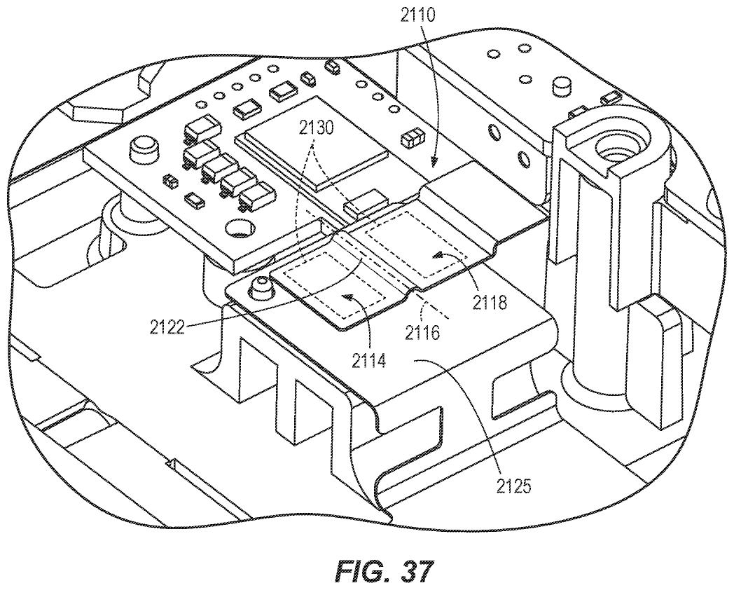

FIGS. 36 and 37 illustrate a battery pack 2000 in accordance with some embodiments of the present disclosure. The battery pack 2000 includes battery pack electronics 2002, including a printed circuit board (PCB) 2100, and the conductive strap assembly 100 having one or more of the conductive straps 102 and corner straps 124, 126. The PCB 2100 may be coupled to a circuit having one or more electrical component(s) (e.g., CPU, a transformer, FETs, etc.), that can be electrically connected to one or more battery cells 120. For example, the PCB 2100 may be coupled to a circuit configured to monitor battery characteristics, to provide voltage detection, to store battery characteristics, to display battery characteristics, to inform a user of certain battery characteristics, to suspend current within the battery pack, to detect temperature of the battery pack, battery cells, and the like, to transfer heat from and/or within the battery pack, and to provide balancing methods when an imbalance is detected within one or more battery cells. In some embodiments, the circuit may include a voltage detection circuit, a boosting circuit, a state of charge indicator, and the like. The PCB 2100 may securably coupled to (e.g., by welding) and supported by a housing or a frame of the battery pack 2000.

In the illustrated embodiment of the battery pack 2000, the corner straps 124, 126 may include a PCB contact part 125 (FIGS. 1-3) securably coupled to and extending from one end of the strap 124. In some embodiments, the PCB contact part 125 is integrally formed with the corner strap 124. The PCB contact part 125 is configured to couple to a PCB connector 2110. The PCB connector 2110 is supported on the battery pack 2000 and is in electrical connection with the PCB 2100. For example, the PCB connector 2110 may be securably coupled to (e.g., by welding) and extend from the PCB 2100 at one side of the PCB 2100. An end of the PCB connector 2110 is positioned adjacent the PCB contact part 125. In particular, the illustrated PCB connector 2110 includes first and second welding plates 2114, 2118 (FIG. 31) for electrically coupling the connector 2110 to the PCB contact part 125, and a raised portion 2122 extending along a partition line 2126 positioned between the welding plates 2114, 2118 and extending above a contact surface of the PCB contact part 125. To facilitate the electrical connection between the welding plates 2114, 2118 and the PCB contact part 125, each of the welding plates 2114, 2118 has a respective welding portion 2130 where each of the plates 2114, 2118 can be laser welded to the PCB contact 125. After the one of the plates 2114, 2118 is welded to the PCB contact part 125, the electrical current from the battery cells 120 is carried to a flexible circuit 2134, which electrically couples the PCB connector 2110 to the PCB 2100, for example, so that a voltage and/or current condition of the battery cells 120 can be monitored.

In some cases, when the PCB 2100 is deemed faulty, a user is required to disconnect the PCB 2100 from the battery pack 2000 via the PCB connector 2110. Typically, this requires the user to discard the entire PCB 2100 and PCB connector 2110 assembly, as the PCB connector 2110 is typically hard welded onto the PCB contact part 125 in a single place and cannot be simply removed without potentially damaging the battery pack 2000. To combat this issue, when a PCB 2100 is first installed in the battery pack 2000, the first welding plate 2114 of the PCB connector 2110 is laser welded to the PCB contact part 125, while the second welding plate 2118 remains un-welded to the PCB contact part 125, relying on the raised portion 2122 to electrically couple the first welding plate 2114 to the PCB connector 2110 and subsequently the PCB 2100. Therefore, if the PCB 2100 is deemed faulty, the user can simply cut the raised portion 2122 along the partition line 2126, and simply remove the faulty PCB 2100. And, when the user is ready to install a new PCB 2100, they can simply laser weld the second welding plate 2118 to the PCB contact part 125 to re-initiate the electrical connection between the PCB connector 2100 and the battery pack 2000 without needing to sacrifice any valuable components. This is advantageous as it saves both time and money on expensive components.

In other embodiments of the battery pack 2000, the pack 2000 can include any of the embodiments of the conductive straps 202, 302, 402, 502, 602, 702, 802, 902, 1002, 1102, 1202, 1302 to facilitate the electrical connection to the PCB connector 2110. In other embodiments, the battery pack 2000 could be a 12 V, 18 V, or 80 V system, or any other common battery pack voltage system commonly known and used by someone having ordinary skill in the art.

Various features of the disclosure are set forth in the following claims.

What is claimed is:

1. A conductive strap for a battery pack, the conductive strap comprising:
a pair of contact tabs, the contact tabs separated by a separation gap defined in the conductive strap, each contact tab including at least one contact dimple; and
a cutout portion defined in the conductive strap and being continuous with the separation gap;
wherein the cutout portion and the separation gap are enclosed by the conductive strap; and
wherein the cutout portion includes an arcuate slot at least partially surrounding the contact tab.

2. The conductive strap of claim 1, wherein
the cutout portion includes a first cutout portion and a second cutout portion; and
the first cutout portion, the separation gap, and the second cutout portion are continuous.

3. The conductive strap of claim 1, wherein each contact tab is asymmetrical.

4. The conductive strap of claim 1, wherein each contact tab is shaped as a truncated semicircle.

5. The conductive strap of claim 1, wherein the enclosed area is generally circular, a diameter of the enclosed area ranging from 12 millimeters to 17 millimeters.

6. The conductive strap of claim 2, wherein
each contact tab is connected to the conductive strap by a connection extension; and
an angle between the connection extension of each contact tab ranges between 70 degrees and 90 degrees.

7. The conductive strap of claim 6, wherein the separation gap and the second cutout portion are included in the angle measurement.

8. The conductive strap of claim 2, wherein
the conductive strap defines a conductive strap plane;
the pair of contact tabs define a contact tab plane; and
the contact tab plane is offset from the conductive strap plane.

9. The conductive strap of claim 8, wherein the conductive strap plane is parallel to the contact tab plane, the contact tab plane being offset from the conductive strap by a distance ranging from 0.5 millimeters to 2.0 millimeters.

10. The conductive strap of claim 8, wherein the arcuate slot, the first cutout portion, and the separation gap are continuous.

11. The conductive strap of claim 10, wherein
the conductive strap further includes an angled extension connecting the contact tab to the remainder of the conductive strap; and
the angled extension spans between the conductive strap plane and the contact tab plane.

12. The conductive strap of claim 2, further comprising
a route from one contact dimple on a first contact tab, about the second cutout portion, and to one contact dimple on a second contact tab; and
wherein the distance of the route ranges from 16.5 millimeters to 20 millimeters.

13. The conductive strap of claim 1, wherein the width between an edge of the conductive strap and an outermost edge of the first cutout portion ranges from 4 millimeters to 10.5 millimeters.

14. A conductive strap for a battery pack, the conductive strap comprising:
a plurality of battery contact portions, each battery contact portion having at least one contact tab, each contact tab including at least one contact dimple;
wherein a subset of the battery contact portions includes more than one contact tab; and
wherein at least one battery contact portion includes a single contact tab.

15. The conductive strap of claim 14, wherein the battery contact portion with a single contact tab has a different arrangement than the subset of battery contact portions with more than one contact tab.

16. The conductive strap of claim 15, wherein the subset of the battery contact portions includes all but one of the contact portions.

17. The conductive strap of claim 14, wherein the subset of the battery contact portions with more than one contact tab further comprises a separation gap defined in the conductive strap between the respective contact tabs of each pair of the contact tabs.

18. The conductive strap of claim 17, further comprising a cutout portion defined in the conductive strap and being continuous with the separation gap.

19. The conductive strap of claim 14, wherein each contact tab is shaped as a truncated semicircle.

20. A method of installing a conductive strap on a battery cell, the method comprising:
aligning a pair of contact tabs of the conductive strap to an end of the battery cell, the pair of contact tabs are at least partially surrounded by an arcuate slot;
pressing a welding header against the pair contact tabs of the conductive strap towards the end of the battery cell;
flexing a connection extension piece corresponding to each contact tab to independently move the contact tabs relative to a remainder of the conductive strap, thereby engaging the end of the battery cell with contact dimples of the contact tabs; and
resistance welding each of the pair of contact tabs to the end of the battery cell at the contact dimples.
